(19) United States
(12) Patent Application Publication
(10) Pub. No.: US 2026/0238066 A1
(43) Pub. Date: Aug. 13, 2026

(54) STATOR, RADIAL FLUX DOUBLE-ROTOR MACHINE AND METHOD OF MANUFACTURE

(71) Applicant: DeepDrive GmbH, Garching (DE)

(72) Inventors: Valentin UNTERFRAUNER, München (DE); Alexander ROSEN, Osnabrück (DE)

(21) Appl. No.: 19/536,618

(22) Filed: Feb. 11, 2026

(30) Foreign Application Priority Data
Feb. 11, 2025 (DE) 102025104954.8

(51) Int. Cl. H02K 3/52; H02K 1/16; H02K 1/18; H02K 3/12

(52) U.S. Cl. CPC H02K 3/522; H02K 1/16; H02K 1/185; H02K 3/12

(57) ABSTRACT

The present invention relates to a stator for a radial flux double-rotor machine with a stator core and a winding placed in the stator core and configured to be self-supporting for torque support of the stator, the winding projecting beyond the stator core at at least one axial end and the stator further has a carrier device, which is arranged axially offset from the stator core and in positive engagement with the winding at the at least one axial end for torque support, the carrier device being configured at least in portions as an electrical insulator and being arranged between the stator core and a winding head of the winding, the winding head having a heat sink which is separate from the carrier device. The present invention further relates to a radial flux double-rotor machine comprising a stator of this type and to a method for manufacturing it.

### CROSS REFERENCE TO RELATED APPLICATION

This claims the benefit of German Patent Application No. DE 102025104954.8, filed Feb. 11, 2025, the content of which is hereby incorporated by reference in its entirety.

### FIELD OF THE INVENTION

The present invention relates to a stator for a radial flux double-rotor machine, in particular for a wheel hub motor, to a radial flux double-rotor machine comprising a stator of this type and to a method for manufacturing a stator for a radial flux double-rotor machine.

### TECHNICAL BACKGROUND

DE 10 2021 003 942 A1 describes a radial flux double-rotor machine comprising a winding, placed in the stator core and configured to be self-supporting for torque support of the stator, and a carrier device, which is arranged axially offset from the stator core and configured for positive engagement with the winding and which transmits the torque. The carrier device is made of a thermally conductive material and thus simultaneously serves to dissipate heat from the winding or the stator. Aluminium was preferably used for this purpose. As a result, the carrier device has high mechanical strength and simultaneously ensures good thermal contact between the winding and the cooling element. However, a briefly high heat generation due to the different thermal expansions of aluminium and the ferromagnetic material of the stator core, for example steel, can cause undesirable additional stress on the components.

### SUMMARY OF THE INVENTION

Against this background, an aspect of the present invention is to provide an improved stator for a radial flux double-rotor machine.

Accordingly, the following are provided:
a stator for a radial flux double-rotor machine, in particular for a wheel hub motor, comprising: a stator core; a winding placed in the stator core and configured to be self-supporting for torque support of the stator, the winding projecting beyond the stator core at at least one axial end; and a carrier device arranged axially offset from the stator core and in positive engagement with the winding at the at least one axial end for torque support, the carrier device being configured at least in portions as an electrical insulator and being arranged between the stator core and a winding head of the winding, the winding head having a heat sink which is separate from the carrier device.
a radial flux double-rotor machine, in particular for a wheel hub drive, comprising: a mechanically fixed base; a stator according to the invention, the carrier device being in positive engagement with at least one axial end of the winding for torque support and being supported at the base; a first rotor arranged radially inside the stator core; and a second rotor arranged radially outside the stator core.
a method for manufacturing a stator for a radial flux double-rotor machine, in particular a stator according to the invention, comprising the steps of: providing a stator core with radially outer stator slots and radially inner stator slots; arranging a carrier device configured for torque support axially offset from the stator core, the carrier device being configured at least in portions as an electrical insulator; inserting individual conductor bars through the inner and outer stator slots and through openings or recesses of the carrier device; connecting the conductor bars inserted into the inner and outer stator slots at the conductor bar ends to form a winding head, in such a way that the carrier device is arranged between the stator core and the winding head; and arranging a heat sink which is separate from the carrier device on the winding head.

A finding behind the present invention is that relative movement between the stator core, conductor and carrier device, due to different thermal expansion coefficients, and the associated stresses under high thermal load can be avoided by selecting a suitable material for the carrier device.

One of the ideas behind the present invention is to avoid thermomechanical stresses of this type using deliberate functional separation, while simultaneously preventing insulation faults. For this purpose, it is proposed to configure the carrier device for torque support as an electrical insulator at least in portions and to arrange it between the stator core and a winding head, while the heat dissipation is ensured primarily via a heat sink separate from the carrier device and provided on the winding head.

In this way, a material for the carrier device having an equal or similar thermal expansion coefficient can be selected, without having to consider the thermal conductivity. Instead, the carrier device may be configured as an electrical insulator or at least contain an electrically insulating material, so that not only is the stress on the conductors reduced (for the same torque), but protection against insulation faults is also achieved in a synergistic manner.

Furthermore, the carrier device can be significantly more compact, in particular with regard to axial extent, because no heat transfer surface to the conductors is required.

By contrast, the separate heat sink at the winding head can be made of a material optimised for heat conduction and can be optimised freely in terms of shape for heat transfer. For example, the heat sink may surround the conductors or engage between them in part, in such a way that a comparatively larger or maximum heat transfer surface area and therefore more effective cooling are provided. Furthermore, because of its good accessibility the heat sink can have a liquid cooling system. Overall, this improves cooling performance and further reduces thermal expansion effects, and this in turn reduces the thermomechanical stress on the components.

For manufacture, the conductors are connected to a winding head only after being passed through the stator slots of the stator and openings or recesses of the carrier device. Preferably, a materially bonded connection is provided by welding, in particular laser beam welding, or soldering. Thus, initially the winding is positively connected to the stator core and carrier device, and subsequently the heat sink is attached to the winding head. The manufacture therefore still involves integral production of the winding within the existing stator core. The positive connection of the conductors to the carrier device is integrated into the step of inserting the conductor bars as a joint step, in such a way that, in spite of the additional step of arranging the heat sink, production as a whole does not become more complex.

Advantageous configurations and developments will be apparent from the further dependent claims and from the description with reference to the figures of the drawings.

In one embodiment, the carrier device is made of an electrically insulating material whose thermal expansion coefficient is substantially equal to the thermal expansion coefficient of the stator core. In particular, the difference between the thermal expansion coefficients is less than 50%. Preferably, the difference between the thermal expansion coefficients is less than 20%. Particularly preferably, the difference is less than 10%. In this way, the stator core and the carrier device expand to approximately the same extent under thermal stress. Thus, even under high thermal stress, mechanical stress is kept within the permissible range without damaging the components or their insulation.

In one embodiment, a thermal expansion coefficient of the carrier device is in a range of approximately 10 10⁻⁶K⁻¹ to 15 10⁻⁶K⁻¹. Advantageously, it is thus in the range of steel, which is conventionally used as the material for the stator core.

In one embodiment, a load-bearing portion of the carrier device is made of steel and has, at least in portions, in particular in the contact region with the winding and stator core, a layer or sheathing of an electrically insulating material. Thus, the same material, steel, is predominantly used as is conventionally the case for the stator core. Only the layer or sheathing therefore has a different thermal expansion coefficient, in such a way that the overall thermal expansion of the carrier device is almost equal to that of the stator core or has only a minor difference which is dependent on the layer or sheathing.

In one embodiment, the electrically insulating material comprises a temperature-resistant plastics material whose glass transition temperature is above 100° C., preferably above 200° C., particularly preferably above 300° C. Advantageously, the material properties of the plastics materials in terms of the thermal expansion coefficient can be adjusted, in such a way that a thermal expansion coefficient equal to that of the stator core is preferably selected. The glass transition temperature is also adjustable and is above a temperature range provided for operation. In particular, the glass transition temperature may be selected equal to or higher than that of a potting compound of the stator. As an alternative to a glass transition temperature, depending on the type and composition of the plastics material, this may be a degradation temperature or thermal decay temperature, which is equally to be understood as a temperature limit for operation.

In one embodiment, the temperature-resistant plastics material is fibre-reinforced, in particular with mineral fibres. In this way, reinforcement or increased strength can be achieved. In particular in the case of mineral or glass fibres, the resulting material is still insulating. These may be short, long, or continuous fibres.

In one embodiment, the heat sink can be arranged axially on the winding head, in particular can be placed on the winding head without torque transmission. Advantageously, it is therefore force-free and also easily accessible from the outside for heat dissipation, for example via a liquid cooling system.

In one embodiment, the heat sink is formed substantially with a negative shape of the winding head, the winding in particular being formed from interconnected conductor bars and having a radially inner layer of helically arranged conductor bars and a radially outer layer of oppositely helically arranged conductor bars, the heat sink engaging at least in part between the conductor bars and/or contacting the conductor bars on their longitudinal side faces. Advantageously, this increases the heat transfer area from the self-supporting winding to the heat sink.

In one embodiment, the heat sink is potted, in particular with a thermally conductive resin, to reduce thermal resistance and/or for fastening to the winding head. In this way, mechanical contacting can be configured with larger tolerances or even avoided altogether. This is advantageous because, at the winding head, dimensional deviations due to the joining process are possible which, with the potting compound or resin, are not detrimental or are compensated for.

In one embodiment, the heat sink is clamped or screwed to the winding head for fastening. Advantageously, this fastening does not need to bear any loads and is only for arranging the heat sink on the winding head.

In one embodiment, the carrier device is configured as an annular disc provided with stiffening elements. In particular stiffening ribs or spokes are conceivable as stiffening elements. In this way, by comparison with a flat annular disc, higher tilting stiffness and torsional stiffness of the carrier device can be provided without increasing the axial extent or the use of material.

In one embodiment of the radial flux double-rotor machine, the base includes a stator carrier which has a clamping device for mounting the carrier device. In particular, the clamping device is configured circumferential and fully encloses the carrier device. The clamping device is configured to counteract radial thermal expansion of the carrier device. In this way, the thermal expansion of the carrier device is advantageously limited mechanically.

In one embodiment, the heat sink contains a thermally conductive material. In particular, this is a metal, preferably an aluminium alloy. The heat sink is coupled to the base in a heat-transferring manner, the base having a cooling device configured to absorb heat dissipated via the heat sink from the winding. In particular, this may be a liquid cooling system. In this way, effective heat dissipation from the heat sink is provided.

The above configurations and developments can be combined with one another, within reason. Further possible configurations, developments and implementations of the invention also include combinations not explicitly mentioned of features of the invention which are described above or in the following in relation to the example embodiments. In particular, a person skilled in the art will also add individual aspects to each basic form of the present invention as improvements or additions.

### CONTENTS OF THE DRAWINGS

The present invention will be explained in greater detail in the following with reference to the example embodiments shown in the schematic drawings, in which:

FIG. 1 is a schematic longitudinal sectional drawing of a stator;

FIG. 2 is a schematic longitudinal sectional drawing of a radial flux double-rotor machine;

FIG. 3 is a longitudinal sectional drawing of a portion of a stator according to one embodiment;

FIG. 4 is a schematic representation of a winding head along with a heat sink;

FIG. 5 is a perspective view of a heat sink;

FIG. 6 is a longitudinal sectional drawing of a portion of a radial flux double-rotor machine according to a further embodiment;

FIG. 7 is a schematic representation of the force flow and heat flow in a stator according to one embodiment; and

FIG. 8 is a flowchart of a method of manufacture.

The accompanying drawings are intended to convey a further understanding of the embodiments of the invention. They illustrate embodiments and serve, in conjunction with the description, to explain the principles and concepts of the invention. Other embodiments and many of the stated advantages will become apparent with reference to the drawings. The elements of the drawings are not necessarily shown to scale.

In the drawings, like, functionally equivalent and equivalently operating elements, features and components are provided with like reference signs in each case, unless stated otherwise.

### DESCRIPTION OF EXAMPLE EMBODIMENTS

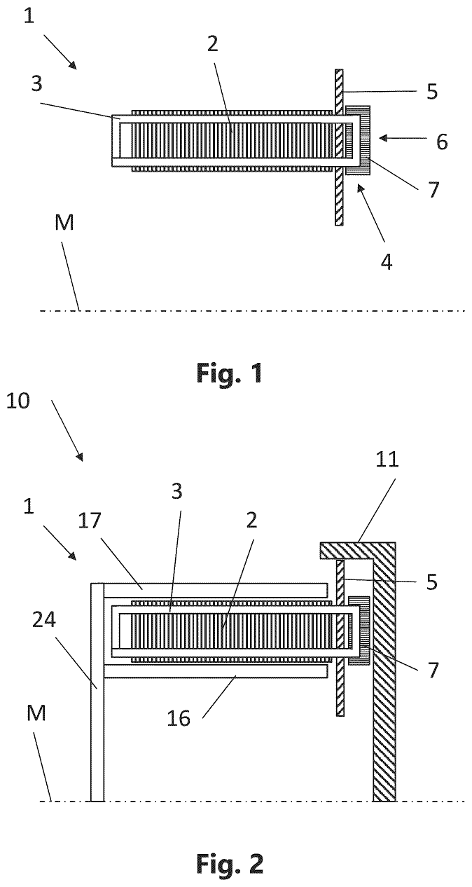

FIG. 1 is a schematic longitudinal sectional drawing of a stator.

This is a schematic diagram of a stator 1 for a radial flux double-rotor machine 10 (see FIG. 2), in particular for a wheel hub motor.

The stator comprises a stator core 2, a winding 3, a carrier device 5 and a heat sink 7. The stator core 2, the winding 3, the carrier device 5 and the heat sink are arranged rotationally symmetrically about the illustrated central axis M.

The winding 3 is configured to be self-supporting for torque support of the stator 1 and projects beyond the stator core 2 at at least one axial end 4. The carrier device 5 is arranged axially offset from the stator core 2 and is positively connected to the winding 3 at one axial end 4 for torque support. In this way, a torque acting on the stator core 2 during the operation of a radial flux double-rotor machine 10 can be supported via the self-supporting winding 3 on the carrier device 5.

The winding contains a conductor material having low electrical resistance, preferably copper. The stator core 2 is preferably made of a soft magnetic material for magnetic flux guidance, for example steel.

The carrier device 5 is configured at least in portions as an electrical insulator and is arranged between the stator core 2 and a winding head 6 of the winding 3. Naturally the winding 3 is electrically insulated. In addition, the carrier device, configured as an electrical insulator, provides protection against insulation faults. Since electrically non-conductive materials are generally also poor thermal conductors, no relevant heat is conducted through the carrier device 5.

The conductors of the winding 3 form a loop at the winding head 6. A comparatively large contact region is thus available there. The winding head 6 has a heat sink 7 which is separate from the carrier device 5 and through which the relevant heat can be dissipated from the conductors of the winding 3.

By contrast, the function of the carrier device 5 is provided to be purely mechanical for torque support. Accordingly, the carrier device 5 is optimised for this purpose with a comparatively low wall thickness.

FIG. 2 is a schematic longitudinal sectional drawing of a radial flux double-rotor machine 10.

This is also a purely illustrative schematic diagram. The radial flux double-rotor machine 10 therefore has, in addition to the stator 1 of FIG. 1, a mechanically fixed base 11, here by way of example in the form of a bearing shield, as well as a first rotor 16 and a second rotor 17, which here by way of example are coupled to one another via a rotor pot 24.

The base 11, the first rotor 16 and the second rotor 17 plus the rotor pot 24 are also constructed rotationally symmetrically around the illustrated central axis M.

The winding 3 is supported on the base 11 via the carrier device 5. For this purpose, the carrier device 5 is fastened to the base in such a way that the torque from the winding 3 can be supported on the base 11 via the carrier device 5.

The first rotor 16 is arranged radially inside the stator core 2 and the second rotor 17 is arranged radially outside the stator core 2.

In the embodiment shown, the torque applied to the stator core is supported by the winding 3 and transferred to the carrier device 5. The carrier device 5 in turn transmits the torque to the base 11.

The heat generated during operation is transferred from the stator core 2 via the winding 3 to the heat sink 7. At the heat sink 7, the heat can be dissipated to the outside, for example via a liquid cooling system and/or a cooling body of the base 11.

The heat sink 7 transmits no or no relevant moment. Preferably, it is force- and moment-free during operation. The carrier device is configured electrically insulating and transmits no or no relevant heat flow. Thus, the functions of moment support via the carrier device 5 and heat dissipation via the heat sink 7 are implemented separately with different, independent components.

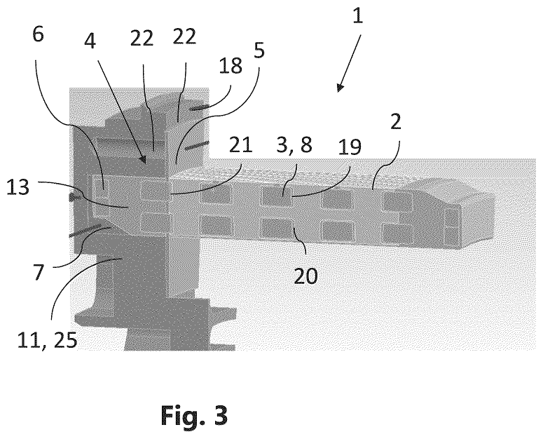

FIG. 3 is a longitudinal sectional drawing of a portion of a stator 1 according to one embodiment.

The stator 1 is shown here together with a bearing shield 25 forming a structural base 11. The carrier device 5 and also the heat sink 7 are mounted in the bearing shield.

The stator core 2 extends axially from a rotor housing to the carrier device 5. Said carrier device is configured as a disc which projects radially beyond the stator core 2 and can be fastened so as to be coupled to the bearing shield 25 for torque support. For this purpose, the base 11 or the bearing shield 25 includes a circumferential stator carrier 18, on which a fastening bore 26 is shown here by way of example. The stator carrier 18 further has a circumferential clamping device 22 for mounting the carrier device 5, which fastens the carrier device 5 circumferentially, for example fully enclosing it with a circumferential shoulder, and clamps it in the event of thermal expansion. In this way, a radial delimitation is formed, in such a way that the clamping device 22 mechanically counteracts radial thermal expansion of the carrier device 5.

The carrier device 5 is made of an electrically insulating material whose thermal expansion coefficient is substantially equal to a thermal expansion coefficient of the stator core 2. There are thus no additional loads on the conductors 8 of the winding 3 in the event of thermal expansions. The difference between the thermal expansion coefficients of the stator core and the carrier device is less than 50%, preferably less than 10%. For this purpose, a thermal expansion coefficient of the carrier device 5 is for example in a range of approximately 10 10⁻⁶K⁻¹ to 15 10⁻⁶K⁻¹, corresponding to a typical range for soft magnetic steel sheets such as are conventionally used for a stator core.

In the embodiment shown, this property is implemented wherein the carrier device contains a temperature-resistant plastics material, whose glass transition temperature is above the permissible temperature range of the stator, as an electrically insulating material. This is in particular dependent on the potting compound used for the stator core and its degradation temperature. Said temperature is above 100° C., preferably above 200° C., and so the glass transition temperature of the temperature-resistant plastics material is also above this value. Particularly preferably, the glass transition temperature of the temperature-resistant plastics material is above 300° C.

The winding head 6, on which the conductors 8 of the winding 3 form a loop, is arranged on the opposite face, facing away from the stator core 2, of the carrier device 5. The heat sink 7 is provided on the winding head 6. The winding head and the heat sink 7 are arranged in a recess of the bearing shield. This recess is additionally filled out with a thermally conductive resin 13 to reduce thermal resistance and fasten the heat sink to the winding head 6.

In other embodiments, however, other arrangements are also conceivable, in particular without a recess of the bearing shield, the heat sink and the winding head being encased in a thermally conductive resin 13. For example, an intermediate space formed by the heat sink itself may also be filled out.

As an alternative to or in addition to the thermally conductive potting compound, the heat sink 7 may be clamped or screwed to the winding head 6 for fastening.

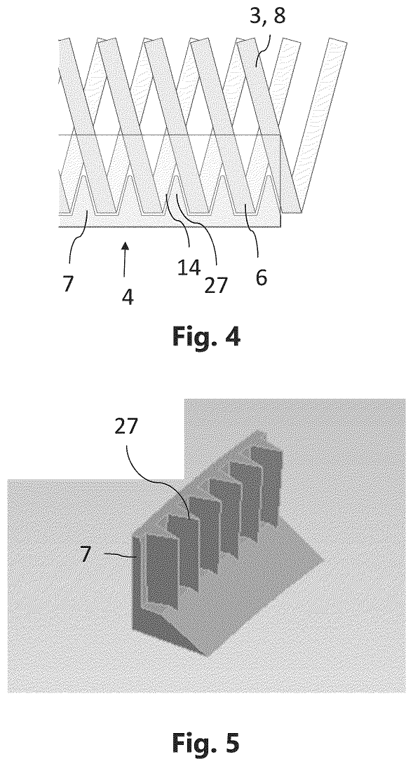

FIG. 4 is a schematic representation of a winding head along with a heat sink.

The conductors 8 of the winding 3, which each form a loop in the winding head 6, are shown schematically here. The winding 3 is formed from interconnected conductor bars 8 and has a radially inner layer of, preferably helically arranged, conductor bars 8 and a radially outer layer of, preferably oppositely helically arranged, conductor bars 8. The heat sink 7 is placed axially on the winding head 6. In the embodiment shown, the heat sink has extensions 27. In this way, it is configured to engage between the conductor bars 8 and thus to contact the conductor bars on their longitudinal side faces 14. In this way, a heat transfer area between the winding and the heat sink is effectively increased, and the heat transfer is thus enhanced.

FIG. 5 is a perspective view of a heat sink.

The heat sink 7 having the extensions 27 is configured to be placed axially on the winding head 6 without any mechanical function, in particular without torque transmission. For this purpose, the heat sink 7 substantially has a negative shape of the winding head 6 so as to provide as large a heat transfer surface as possible. Remaining cavities between the winding head and the heat sink can be filled out with a thermally conductive resin, as was explained with reference to FIG. 3.

The heat sink 7 is made of a thermally conductive material and contains in particular a metal of high thermal conductivity, preferably an aluminium alloy.

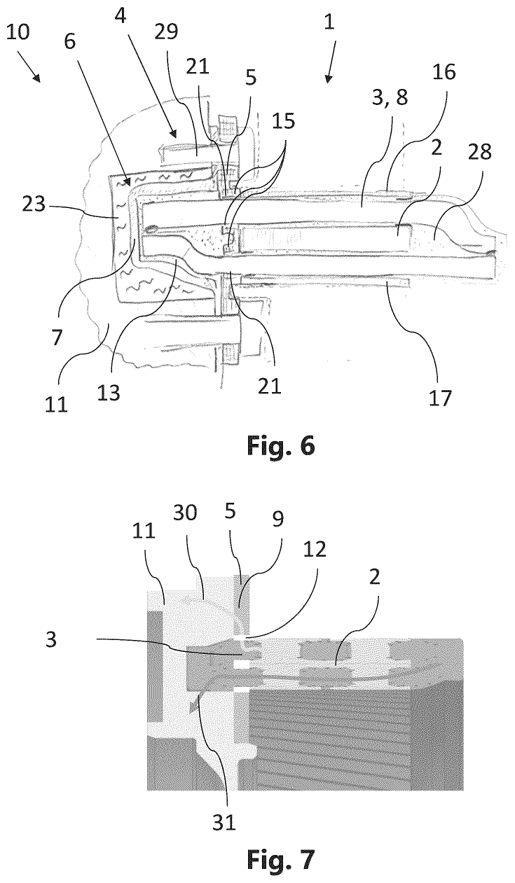

FIG. 6 is a longitudinal sectional drawing of a portion of a radial flux double-rotor machine 10 according to a further embodiment.

In the embodiment shown, a basic structure as described in FIG. 2 is provided, and so functionally equivalent components bear like reference numerals.

The conductors 8 of the winding 3, which are received in the stator core, are configured as bent conductor bars here. The bend is for forming the winding head and closes the radial gap between the radially inner and outer layer in each case. In the region of the stator core 2, up to the carrier device 5, cavities for the conductors 8 are filled with an insulating potting compound 28.

The carrier device 5 is configured as an annular disc, which is provided with stiffening elements 15, here in the form of stiffening ribs, and made of a temperature-resistant and mechanically high-strength plastics material. For example, this may be polyetheretherketone (PEEK) or another temperature-resistant high-performance plastics material having a high long-term service temperature. Aside from polyetheretherketones (PEEK), for example partially aromatic polyamides (PA 66/6T), polyphenylsulphones (PPSU), polyethersulphones (PES), polyetherimides (PEI) and polyphenylene sulphides (PPS) are conceivable, which are among the most advanced high-performance plastics materials.

Fibre-reinforced configurations of plastics materials of this type are also conceivable, in particular mineral-fibre-reinforced or glass-fibre-reinforced plastics materials. Reinforcements embedded in the plastics material, in the form of microfibres and microbodies made of glass or minerals, can lead to higher stiffness and/or mechanical strength as well as heat deflection temperature. For example, glass-fibre-reinforced polyetheretherketone (such as PEEK GF30) may be used.

The conductors 8 are guided through openings or recesses 21 of the carrier device 5, in such a way that a torque transmitted through the winding is supported on the carrier device 5. The carrier device 5 is fastened to the base 11 by fasteners 29 and thus transmits the torque completely to the base 11. To prevent elasticity and tilting, the carrier device is stiffened with the reinforcing elements 15.

The conductors 8 of the winding 3 form, on a face of the carrier device 5 facing away from the stator core, a winding head 6 in which a bent end portion, here of a radially inner conductor, is electrically conductively connected to a straight end portion, here of a radially outer conductor, preferably by material bonding, for example by laser beam welding.

The heat sink 7 is placed axially on the winding head. On a face of the heat sink facing the carrier device, cavities in the winding head are filled with thermally conductive potting compound. On a face of the heat sink 7 facing away from the carrier device, a cooling device 23 in the form of a liquid cooling system or a fluid channel for liquid cooling is provided in the base 11. It is configured to absorb heat dissipated via the heat sink 7 from the winding 3.

The inner and outer rotors 16, 17 of the radial flux double-rotor machine 10 are also indicated by dashed lines.

FIG. 7 is a schematic representation of the force flow and heat flow in a stator according to one embodiment.

As can be seen from the force flow 30, the torque applied in the stator core 2 is transferred via the winding 3 to the carrier device 5 and from there to the base 11.

As an alternative to using a high-performance plastics material, in this embodiment a load-bearing portion 9 of the carrier device 5 therefore is made of steel and provided with a layer or sheathing 12 of an electrically insulating material in portions in the contact region with the winding 3 and stator core 2. This may also for example be a temperature-resistant plastics material, but other insulating and temperature-resistant as well as pressure-resistant materials are also conceivable, for example a ceramic.

As can be seen from the heat flow 31, the heat generated in the stator core 2 and in the winding 3 is transferred to the heat sink 7 and from there to the base 11.

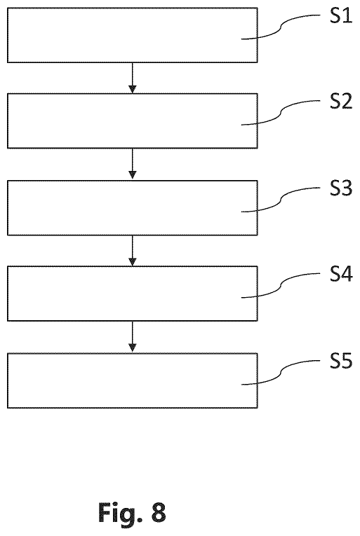

FIG. 8 is a flowchart of a method of manufacture.

This is a method for manufacturing a stator 1 for a radial flux double-rotor machine 10, as described with reference to FIG. 1 to 7.

The method comprises providing S1 a stator core 2 with radially outer stator slots 19 and with radially inner stator slots 20.

The method further comprises arranging S2 a carrier device 5 configured for torque support axially offset from the stator core 2, the carrier device being configured at least in portions as an electrical insulator.

A further manufacturing step consists in inserting S3 individual conductor bars 8 through the inner and outer stator slots 19, 20 and through openings or recesses 21 of the carrier device 5.

The method further comprises connecting S4 the conductor bars 8 inserted into the inner and outer stator slots at the conductor bar ends to form a winding head 6, in such a way that the carrier device 5 is arranged between the stator core 2 and the winding head 6.

Furthermore, a step S5 of arranging a heat sink 7 which is separate from the carrier device 5 on the winding head is provided.

Although the present invention has been fully described above with reference to preferred example embodiments, it is not limited thereto, but can be modified in various ways.

### LIST OF REFERENCE SIGNS

1 Stator
2 Stator core
3 Winding
4 Axial end
5 Carrier device
6 Winding head
7 Heat sink
8 Conductor bars
9 Load-bearing portion
10 Radial flux double-rotor machine
11 Base
12 Sheathing
13 Thermally conductive resin
14 Longitudinal side face
15 Stiffening elements
16 First rotor
17 Second rotor
18 Stator carrier
19, 20 Stator slots
21 Recess
22 Clamping device
23 Cooling device
24 Rotor pot
25 Bearing shield
26 Fastening bore
27 Extension
28 Potting compound
29 Fastener
30 Force flow
31 Heat flow

1. A stator for a radial flux double-rotor machine, comprising:
a stator core;
a winding, placed in the stator core and configured to be self-supporting for torque support of the stator, the winding projecting beyond the stator core at at least one axial end; and
a carrier device arranged axially offset from the stator core and in positive engagement with the winding at at least one axial end for torque support,
wherein the carrier device is configured at least in portions as an electrical insulator and is arranged between the stator core and a winding head of the winding, the winding head having a heat sink which is separate from the carrier device.

2. The stator of claim 1,
wherein the carrier device is made of an electrically insulating material whose thermal expansion coefficient is substantially equal to a thermal expansion coefficient of the stator core.

3. The stator of claim 2,
wherein a difference is less than 20% or less than 10%.

4. The stator of claim 1,
wherein a thermal expansion coefficient of the carrier device is in a range of approximately 10 10⁻⁶K⁻¹ to 15 10⁻⁶K⁻¹.

5. The stator of claim 1,
wherein a load-bearing portion of the carrier device is made of steel and has, at least in portions, in particular in the contact region with the winding and stator core, a layer or sheathing of an electrically insulating material.

6. The stator of claim 2,
wherein the electrically insulating material contains a temperature-resistant plastics material whose glass transition temperature is above 100° C.

7. The stator of claim 6,
wherein the glass transition temperature is above 200° C. or above 300° C.

8. The stator of claim 6,
wherein the temperature-resistant plastics material is fibre-reinforced or mineral-fibre-reinforced.

9. The stator of claim 1,
wherein the heat sink can be arranged axially on the winding head or can be placed on the winding head without torque transmission.

10. The stator of claim 1,
wherein the heat sink is formed substantially with a negative shape of the winding head, the winding being formed from interconnected conductor bars and having a radially inner layer of helically arranged conductor bars and a radially outer layer of oppositely helically arranged conductor bars, the heat sink engaging at least in part between the conductor bars or contacting the conductor bars on their longitudinal side faces.

11. The stator of claim 1,
wherein the heat sink is potted with a thermally conductive resin to reduce thermal resistance and for fastening to the winding head.

12. The stator of claim 1,
wherein the heat sink is clamped or screwed to the winding head for fastening.

13. The stator of claim 1,
wherein the carrier device is configured as an annular disc provided with stiffening elements which provide a higher tilting stiffness and torsional stiffness of the carrier device by comparison with a flat annular disc.

14. A Radial flux double-rotor machine comprising:
a mechanically fixed base;
a stator according to any of the preceding claims, the carrier device being in positive engagement with the at least one axial end of the winding for torque support and being supported at the base;
a first rotor arranged radially inside the stator core; and
a second rotor arranged radially outside the stator core.

15. The radial flux double-rotor machine of claim 14,
wherein the base contains a stator carrier which has a clamping device for supporting the carrier device, the clamping device counteracting a radial thermal expansion of the carrier device.

16. The radial flux double-rotor machine of claim 15,
wherein the stator carrier has a circumferential clamping device which fully encloses the carrier device.

17. The radial flux double-rotor machine of claim 12,
wherein the heat sink contains a thermally conductive material and is coupled to the base in a heat-transferring manner, the base having a cooling device which is configured to absorb heat dissipated via the heat sink from the winding.

18. The radial flux double-rotor machine of claim 17,
wherein the heat sink contains an aluminium alloy or wherein the cooling device is a liquid cooling system.

19. The radial flux double-rotor machine of claim 14,
wherein the radial flux double-rotor machine is configured for a wheel hub drive.

20. A method for manufacturing a stator for a radial flux double-rotor machine, comprising the steps of:
providing a stator core with radially outer stator slots and with radially inner stator slots;
arranging a carrier device configured for torque support axially offset from the stator core, the carrier device being configured at least in portions as an electrical insulator;
inserting individual conductor bars through the inner and outer stator slots and through openings or recesses of the carrier device;
connecting the conductor bars inserted into the inner and outer stator slots at the conductor bar ends to form a winding head, in such a way that the carrier device is arranged between the stator core and the winding head; and
arranging a heat sink which is separate from the carrier device on the winding head.
